(19) United States
(12) Patent Application Publication
(10) Pub. No.: US 2015/0149566 A1
(43) Pub. Date: May 28, 2015

(54) MESSAGING SERVICE ACTIVE DEVICE

(71) Applicant: Viper Media S.a.r.l., Luxembourg (LU)

(72) Inventors: Michael Shmilov, Rishon LeZion (IL); Ido lungelson, Rishon LeZion (IL)

(73) Assignee: Viper Media S.a.r.l., Luxembourg (LU)

(21) Appl. No.: 14/397,211

(22) PCT Filed: Jun. 13, 2013
(86) PCT No.: PCT/IB2013/054838

§ 371 Date: Oct. 27, 2014

Related U.S. Application Data
(60) Provisional application No. 61/672,919, filed on Jul. 18, 2012.

(51) Int. Cl. H04L 12/58; H04W 4/14

(52) U.S. Cl. CPC H04L 51/04; H04W 4/14
USPC 709/206

(57) ABSTRACT

A system and method for communicating messages over messaging service, comprising: receiving a request from a first user device to transmit a message to a second user having one or more communication devices sharing the same account ID; determining at least one active device from the one or more communication devices sharing the same account ID; sending an active status to the selected one or more device; sending an inactive status to the unselected one or more devices; and transmitting the message to the one or more active devices.

### CROSS-REFERENCE TO RELATED PATENT APPLICATIONS

This patent application claims priority from and is related to U.S. Provisional Patent Application Ser. No. 61/672,919, filed Jul. 18, 2012, this U.S. Provisional patent application incorporated by reference in its entirety herein.

### FIELD OF THE INVENTION

The present invention pertains to the field of transmitting messages between end-points over communication means and more particularly to multiple communication devices having the same account ID.

### BACKGROUND

Instant messaging (IM) is a form of real-time direct text-based chatting communication in push mode between two or more people using personal computers or other devices, along with shared clients. The user's text is conveyed over a network, such as the Internet. More advanced instant messaging software clients also allow enhanced modes of communication, such as live voice or video calling and inclusion of links to media.

Most IM programs provide these features:

Instant messages—Send notes back and forth with a friend who is online
Chat—Create a chat room with friends or co-workers
Web links—Share links to your favorite Web sites
Video—Send and view videos, and chat face to face with friends
Images—Look at an image stored on your friend's computer
Sounds—Play sounds for your friends
Files—Share files by sending them directly to your friends
Talk—Use the Internet instead of a phone to actually talk with friends
Streaming content—Real-time or near-real-time stock quotes and news
Mobile capabilities—Send instant messages from your cell phone

The steps involved in originating an IM session are signaling and media channel setup, encoding, packetizing, and transmission as e.g. Internet Protocol (IP) packets over a packet-switched network. On the receiving side, similar steps (usually in the reverse order) such as reception of the IP packets, decoding of the packets and digital-to-analog conversion reproduce the original text or voice stream.

IM is available on many smartphones and Internet devices so that users of portable devices that are not phones may place calls or send text messages over communication channels such as 3G or Wi-Fi.

Multiple devices having different device IDs (DIDs) may share the same account ID.

A device ID may be any ID that uniquely identifies the device. For example: the IP/port the device connects to the service with (note that this is the “external” address—after all NATs); MAC address of network card; randomly generated UDID; IMEI on a cellular network; ID assigned to device by the system at registration; push service's token, and others.

An account ID may be a user ID, an e-mail address or a phone number. For example, a smart phone and a desktop computer can both connect to an IM service with the same phone number. The “normal” behavior for IM services that support multiple devices connecting with the same account ID at the same time (e.g. Skype) is for messages to be received on all devices, each device's behavior being the same—regardless if there are other devices sharing the same account ID.

It may be beneficial that if a message (or a call) is to be delivered to a user, not all devices should behave in the same way. In particular, one device may be “active” and provide notification to the user, such as an audible cue, a visual cue, vibration etc., while another device may be “inactive” and not provide the user with a cue, or provide a different cue—e.g. only display the message or just increase a badge.

### SUMMARY

According to a first aspect of the present invention there is provided a method of communicating messages over messaging service, comprising: receiving a request from a first user device to transmit a message to a second user having one or more communication devices sharing the same account ID; determining at least one active device from said one or more communication devices sharing the same account ID; sending an active status to said selected one or more device; sending an inactive status to the unselected one or more devices; and transmitting the message to said one or more active devices.

Determining may comprise defining the status of a communication device as active if the device is a single device having a given account ID.

Determining may comprise defining the status of a communication device as active if the device is one of a plurality of devices sharing the same account ID and was the last among said plurality of devices to initiate a communication session.

Determining may comprise defining the status of a communication device as active if the device is one of a plurality of devices sharing the same account ID and was selected by the service as the active device.

Determining may comprise defining the status of a communication device as active if a predefined time limit has not yet elapsed since the user selected the device for initiating a communication session.

Determining may comprise defining the status of a communication device as active if the device has communicated by a short range communication protocol with an active device.

Determining may comprise defining the status of all said communication devices as active.

Determining may comprise defining the status of a preselected one of said communication devices as active.

The account ID may comprise one of a telephone number, an e-mail address and an account ID.

The messaging service may be one of an Instant Messaging (IM) service and a Short Message Services (SMS).

According to a second aspect of the present invention there is provided a messaging service system, comprising: a system server comprising a software relay module; and a plurality of service users running a messaging application, at least one of said users having one or more communication devices sharing the same account ID, said communication devices configured to communicate over a network with other users' communication devices, said system server configured to: determine at least one active device from said one or more communication devices sharing the same account ID; send an active status to said at least one determined device; send an inactive status to the unselected one or more devices; and transmit the message to said one or more active devices messaging application.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic drawing of the system component for carrying out the present invention;

FIG. 2 is a schematic drawing showing the data transmission routes according to the present invention;

FIG. 3 is a flowchart showing an exemplary device selection process according to the present invention; and

FIG. 4 is a schematic drawing showing exemplary conditions for active status.

### DETAILED DESCRIPTION OF PREFERRED EMBODIMENTS

The present invention provides a system and method for overcoming the disadvantages of existing Instant Messaging (IM) systems, by having a single active device for each IM session, although several devices may share the same account ID.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

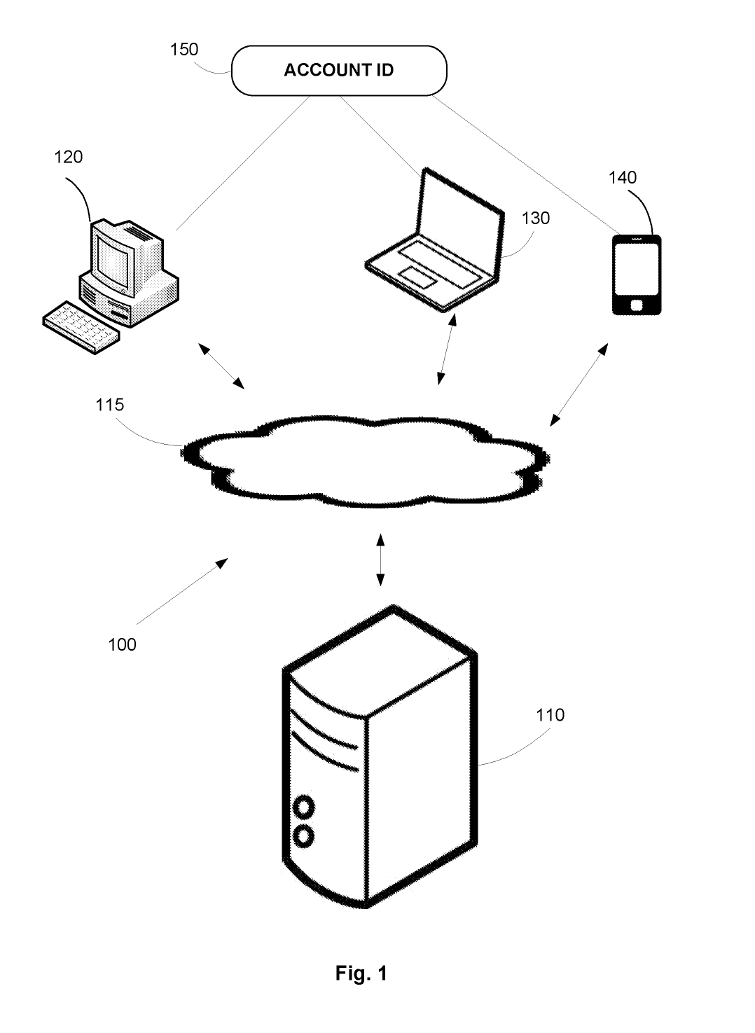

FIG. 1 is a schematic drawing showing the system components for carrying out the present invention. The system 100 comprises a plurality of exemplary communication devices: a computer 120, a laptop 130 and a smartphone 140, sharing the same account ID 150, such as a telephone number or a user name.

The communication devices (120, 130, 140) communicate bidirectionally with the IM service server 110 over a communications network 115 (e.g. Internet), using an IM application such as Viber (www.viber.com),

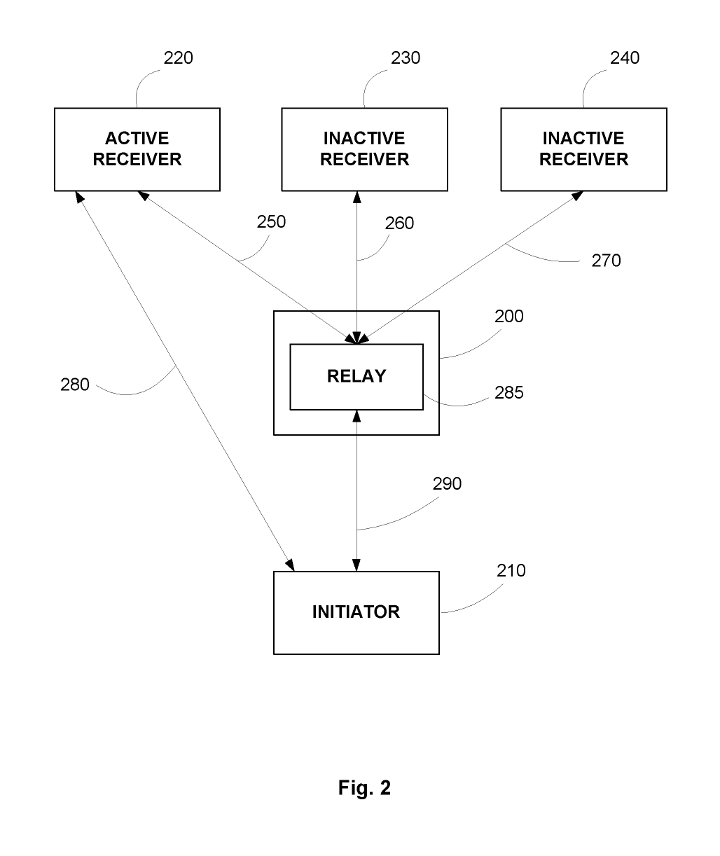

FIG. 2 is a schematic drawing showing the data transmission routes according to the present invention.

An initiator 210, using the IM client application on his communication device, communicates 290 to the service 200 an account ID (e.g. user ID, e-mail address, phone number) of a recipient. The service 200 may communicate the request to the IM client applications of all the devices (220, 230, 240) having the same account ID (optionally with an active/inactive flag), via a software relay mechanism 285, which may be implemented, for example, as a table mapping account-IDs to devices and connections to those devices (e.g. via TCP), or as a push-service by sending a message to all the IM applications running on the devices connected to the account ID using, for example, Google's C2DM service or Apple Push Service.

Alternatively, the service 200 may communicate the request only to the IM client application of the currently active device using similar mechanisms.

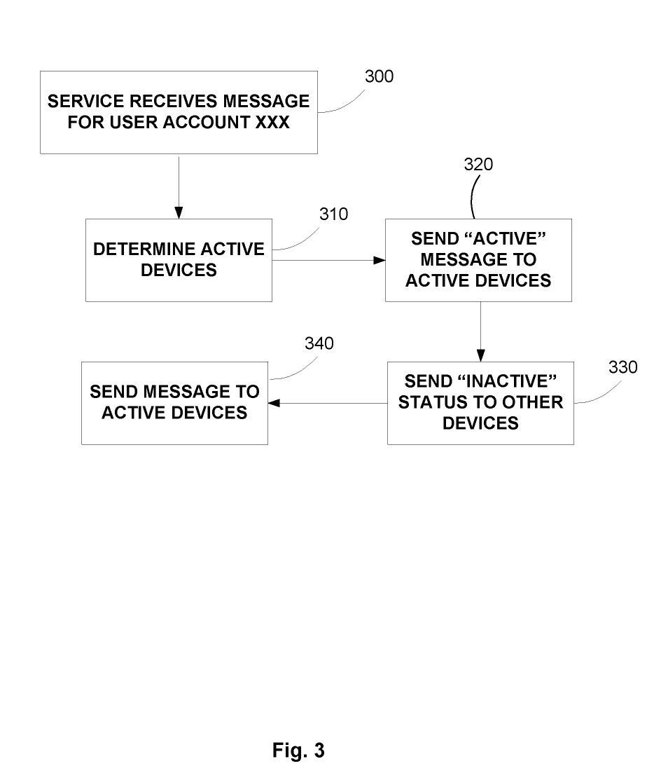

FIG. 3 is a flowchart showing the device selection process according to the present invention.

In step 300, the service receives a message from a user, requesting communication with another user having an account ID XXX, or a direct message to be transferred to the other user (i.e. unsolicited communication).

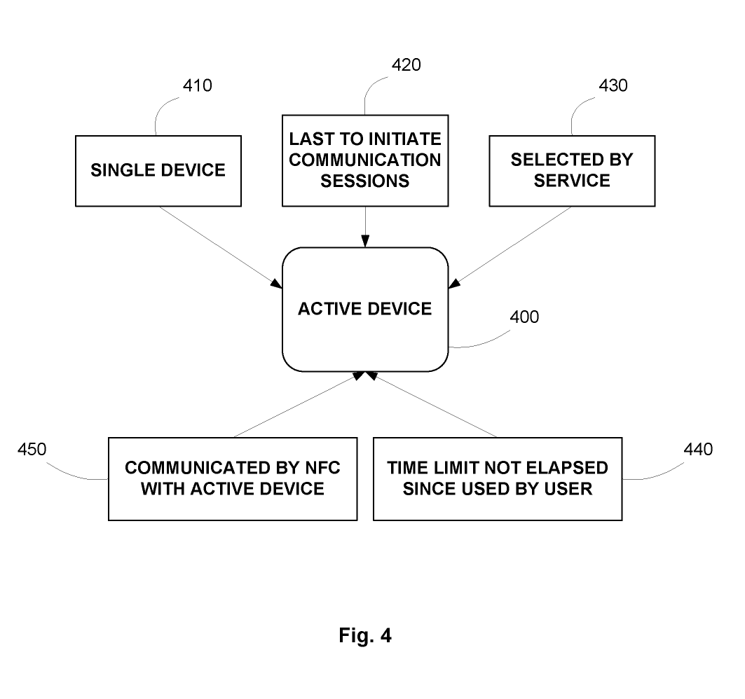

In step 310 the service determines one or more active devices for account ID XXX. This may be done by applying the logic described below in conjunction with FIG. 4 to each device defined for account ID XXX. In step 320 a message is sent by the service to each of the determined active devices, notifying it that it is active. Alternatively, a message may be sent to all devices sharing account ID XXX. The message may be accompanied by a flag indicating the current active device(s) (or none), or each device may just be notified whether it is active or not.

If no device was determined to be active, the service may select all the devices to be active. If more than one device shares account ID XXX, the service proceeds to send silent notifications to all other (not selected) devices, notifying them that they are inactive (in which case the message will be sent to them at a later time, when they become active, e.g. when the user starts the application), or sending the requested message to the inactive devices with an “inactive” flag (step 330). In step 340 the requested message is sent to the active devices.

In an alternative embodiment, the “active” status may be communicated as a flag attached to the active status message, whereby steps 320 and 340 may be unified.

FIG. 4 is a schematic drawing showing exemplary conditions for active status.

According to the example of FIG. 4, a communication device is active (400) if at least one of the following exemplary conditions is true:
The device is a single device having account ID XXX (410);
The device was the last among other devices having account ID XXX to initiate a communication session (420);
The device was selected by the service as an active device (430);
A predefined time limit has not yet elapsed since the user selected the device for initiating a communication session (440);
The device is in close proximity to the current active device and the two devices have communicated by (very) short range communication protocols—such as NFC (450).

It will be understood that other conditions may be applied.

According to embodiments of the present invention a device may cease to be active, i.e. change its status from “active” to “inactive” if at least one of the following exemplary conditions is true:
Another device having account ID XXX became active;
A predefined time limit has elapsed since the user selected the device for initiating a communication session;
The device is no longer in near proximity to the Smartphone having the same account ID. This condition uses the underlying assumption that a Smartphone is always in near proximity to the user.

If no device is currently defined as “active”, e.g. when no communication took place for the account ID for at least a pre-defined period, a new incoming message may be directed to all the devices. Alternatively, a default active device may be defined, e.g. Smartphone.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

For example, the present invention may also apply to Short Message Services (SMS) using a circuit-switched network.

Each device in this network has a device ID (e.g. IMEI) and the mobile service can send messages to that device. The account ID in this network is the phone number and multiple devices may share it. An Active device may be the last device that performed an “action” such as sending an SMS, making or receiving a phone call.

1. A method of communicating messages over messaging service, comprising:
receiving a request from a first user device to transmit a message to a second user having one or more communication devices sharing the same account ID;
determining at least one active device from said one or more communication devices sharing the same account ID;
sending an active status to said selected one or more device;
sending an inactive status to the unselected one or more devices; and
transmitting the message to said one or more active devices.

2. The method of claim 1, wherein said determining comprises defining the status of a communication device as active if the device is a single device having a given account ID.

3. The method of claim 1, wherein said determining comprises defining the status of a communication device as active if the device is one of a plurality of devices sharing the same account ID and was the last among said plurality of devices to initiate a communication session.

4. The method of claim 1, wherein said determining comprises defining the status of a communication device as active if the device is one of a plurality of devices sharing the same account ID and was selected by the service as the active device.

5. The method of claim 1, wherein said determining comprises defining the status of a communication device as active if a predefined time limit has not yet elapsed since the user selected the device for initiating a communication session.

6. The method of claim 1, wherein said determining comprises defining the status of a communication device as active if the device has communicated by a short range communication protocol with an active device.

7. The method of claim 1, wherein said determining comprises defining the status of all said communication devices as active.

8. The method of claim 1, wherein said determining comprises defining the status of a preselected one of said communication devices as active.

9. The method of claim 1, wherein said account ID comprises one of a telephone number, an e-mail address and an account ID.

10. The method of claim 1, wherein said messaging service is one of an Instant Messaging (IM) service and a Short Message Services (SMS).

11. A messaging service system, comprising:
a system server comprising a software relay module; and
a plurality of service users running a messaging application, at least one of said users having one or more communication devices sharing the same account ID,
said communication devices configured to communicate over a network with other users' communication devices,
said system server configured to:
determine at least one active device from said one or more communication devices sharing the same account ID;
send an active status to said at least one determined device;
send an inactive status to the unselected one or more devices; and
transmit the message to said one or more active devices messaging application.

12. The system of claim 11, wherein said determining comprises defining the status of a communication device as active if the device is a single device having a given account ID.

13. The system of claim 11, wherein said determining comprises defining the status of a communication device as active if the device is one of a plurality of devices sharing the same account ID and was the last among said plurality of devices to initiate a communication session.

14. The system of claim 11, wherein said determining comprises defining the status of a communication device as active if the device is one of a plurality of devices sharing the same account ID and was selected by the service as the active device.

15. The system of claim 11, wherein said determining comprises defining the status of a communication device as active if a predefined time limit has not yet elapsed since the user selected the device for initiating a communication session.

16. The system of claim 11, wherein said determining comprises defining the status of a communication device as active if the device has communicated by a short range communication protocol with an active device.

17. The system of claim 11, wherein said determining at least one active device from said one or more communication devices sharing the same account ID comprises defining the status of all said communication devices as active.

18. The system of claim 11, wherein said determining at least one active device from said one or more communication devices sharing the same account ID comprises defining the status of a preselected one of said communication devices as active.

19. The system of claim 11, wherein said account ID comprises one of a telephone number, an e-mail address and an account ID.

20. The system of claim 11 wherein said messaging service is one of an Instant Messaging (IM) service and a Short Message Services (SMS).
